(19) United States
(12) Patent Application Publication
(10) Pub. No.: US 2012/0027389 A1
(43) Pub. Date: Feb. 2, 2012

(54) APPARATUS AND METHOD FOR CONTROLLING AIR FLOW

(76) Inventor: Justin Klabin, Montclair, NJ (US)

(21) Appl. No.: 13/195,301

(22) Filed: Aug. 1, 2011

Related U.S. Application Data
(60) Provisional application No. 61/369,908, filed on Aug. 2, 2010.

(51) Int. Cl. A47K 10/48; F26B 21/00

(52) U.S. Cl. 392/381; 34/90

(57) ABSTRACT

Apparatus and method for controlling air flow of a drying unit. The apparatus includes a housing mounted below the dryer unit and a frame member coupled to the housing member. The frame member functions to intersect and deflect the air flow in a direction away from a floor surface.

### FIELD OF THE INVENTION

Embodiments of the invention relate to control of air flow, and more particularly relate to an apparatus and method for controlling air flow for use with air hand drying systems.

### BACKGROUND OF THE INVENTION

Air hand drying systems such as high velocity hand dryers are an efficient means of drying hands while also reducing the cost and waste associated with paper towels. According to a study by Ansari et al, “the interior of a hand dryer has bacteria counts two to four times lower than other surfaces in the bathroom, such as sinks, doorknobs and soap dispensers.” This study is disclosed in the website, http://www.bmmag.com, Vol. 9, Issue 1, January 2009.

A typical high velocity dryer unit 10 is illustrated in FIG. 1. As shown in FIG. 1, the down blast of air is released from air exhaust port 12 under the dryer unit 10. The major issue with such high velocity dryer is caused by the down blast of air from the air exhaust port 12 under the drying unit 10 where hands (not shown) are positioned for drying. The direction of air flow is represented by the arrows as shown in FIG. 1. The blast of air flows downward directly on a floor surface, s below the drying unit 10 where particles, p such as dirt, dust, debris, chemicals, etc. are forced into the air. These particles are typically contaminated with bacteria and viruses that are spread through the air.

Thus, there is a need to provide a system and method of reducing or eliminating flow of unwanted or undesirable particles in the air in the area proximate the floor surface.

It is also desirable to provide an apparatus which may be readily and securely inserted in position proximate the hand dryer for easier usage.

### SUMMARY OF THE INVENTION

Embodiments of the invention solve these and other needs by methods and apparatuses for controlling air flow blown from the drying units. Embodiments of the present invention provide for methods and apparatuses that function to control an air flow by intersecting a column of air and safely diverting it away from the floor surface and into the air column where it decelerates harmlessly.

The apparatus includes a housing mounted below the drying units and one or more frame members coupled to the housing member. The one or more frame members function as deflectors to intersect and deflect air flow in a direction away from the floor surface. In the embodiments of the present invention, the one or more frame members function to redirect air first horizontally and then vertically which safely diverts it nearly perpendicular to and away from the floor surface

In one embodiment of the present invention, the frame member includes a first deflecting surface and a second deflecting surface both of which function to intersect and deflect the air flow in a direction away from the floor surface.

In another embodiment of the present invention, the frame member includes a first frame and a second frame both of which function to intersect and deflect the air flow in a direction away from the floor surface.

In further embodiments of the present invention there is a method for controlling the air flow operating the apparatus as described above.

### BRIEF DESCRIPTION OF THE DRAWINGS

FIG. 1 illustrates a schematic view of the dryer unit of prior art.

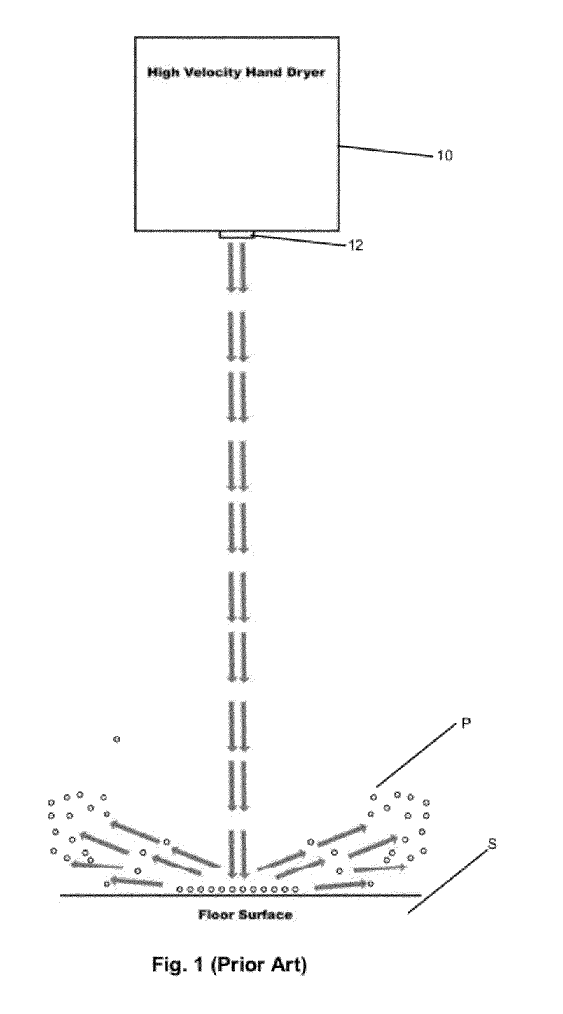

FIG. 2A illustrates a schematic view of an apparatus for controlling air flow in accordance with an embodiment of the invention;

FIG. 2B illustrates a schematic view of the apparatus of FIG. 2A in conjunction or in use with the dryer unit;

FIG. 3A illustrates a schematic view of an apparatus for controlling air flow in accordance with another embodiment of the invention; and

FIG. 3B illustrates a schematic view of the apparatus of FIG. 3A in conjunction or in use with the dryer unit.

### DETAILED DESCRIPTION OF THE INVENTION

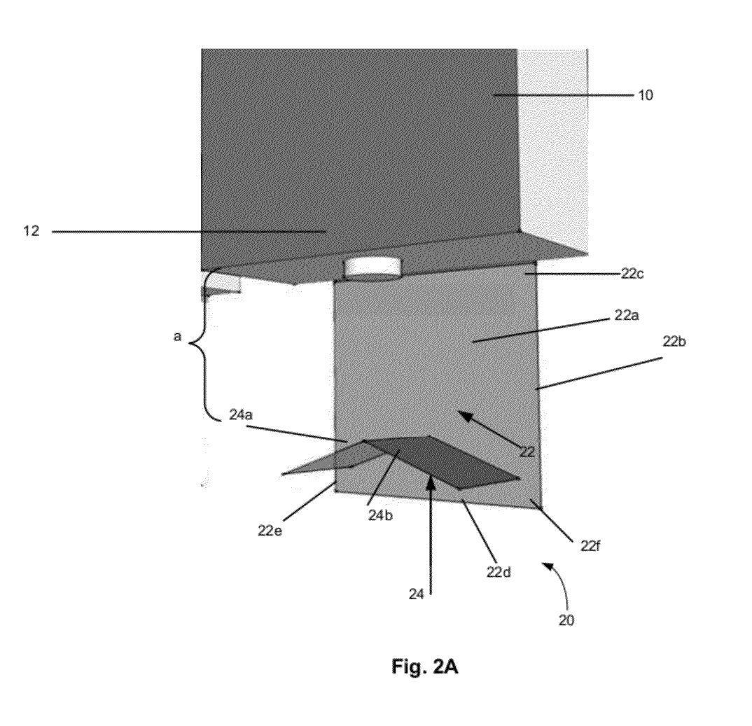

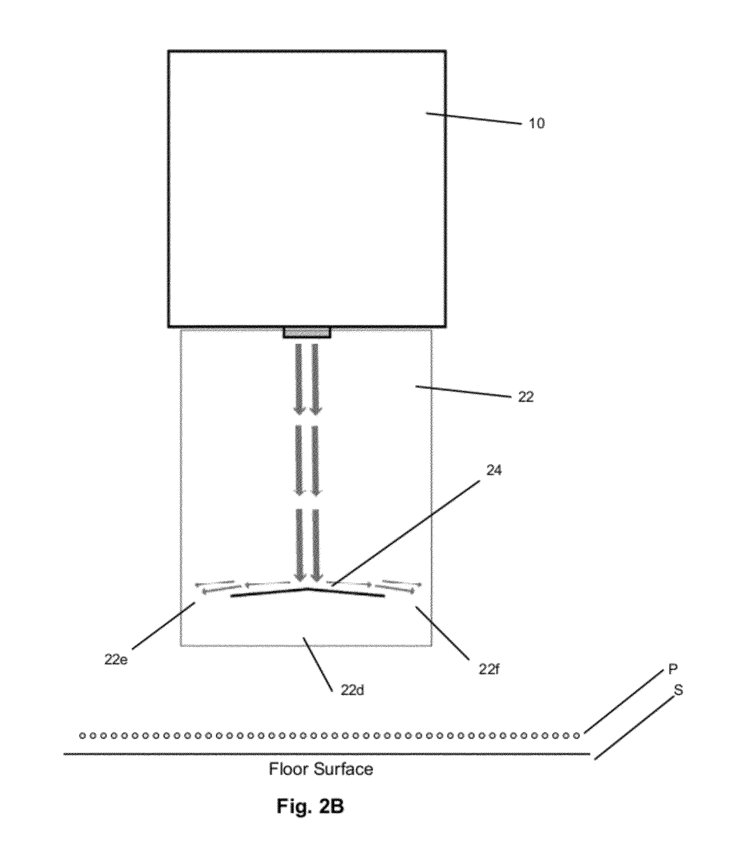

Referring to FIG. 2A there is shown a perspective view of an apparatus to control air flow in accordance with one embodiment of the present invention. The air controller apparatus 20 includes a housing 22 of an elongate, semi-enclosed substantially flat member mounted preferably to a wall (not shown). It is noted that the housing 22 is substantially rectangular in shape, however, the invention is not limited to a rectangular form and the housing may be another suitable shape such as for example, circular, triangular, square etc. The housing 22 is preferably made of any suitable, conventional sheet metal. However, one skilled in the art would appreciate that the housing may preferably be constructed of other materials such as plastic, wood, fiberglass etc. As shown in FIG. 2A, the housing 22 includes a front portion 22a, a rear portion 22b, top portion 22c and a bottom portion 22d, left side 22e of the bottom portion 22d and right side 22f of the bottom portion 22d. The rear portion 22b is mounted to a wall (not shown). As illustrated in FIG. 2A, the apparatus 20 also includes a frame member 24 shaped preferably in substantially inverted V configuration securely mounted to the bottom portion 22d of the housing 22. It is noted that the frame member 24 is substantially rectangular in an inverted V shape configuration, however, the invention is not limited to this shape and/or form and the frame member may be another suitable shapes and/or forms known to one skilled in the art. The frame member 24 is preferably made of any suitable, conventional sheet metal. However, one skilled in the art would appreciate that the frame member may preferably be constructed of other materials such as plastic, fiberglass or other suitable materials known to one skilled in the art having benefit of this disclosure. The frame member 24 includes first and second deflecting surfaces 24a and 24b each of which include a slope. In the embodiment shown in FIG. 2A, the frame member 24 includes two deflecting surfaces 24a and 24b as a one piece member with each end of the deflecting surfaces 24a and 24b connected to the bottom portion 22d of the housing 22. In another embodiment, the frame member 24 may include two separate incline components joined together at one end and other end connected to the bottom portion 22d of the housing 22. The frame member 24 functions as a baffle to direct air flow away from a floor surface (not shown) as will be described in greater detail with respect to FIG. 2A herein below.

Referring to FIG. 2B, there is shown the perspective view of the air flow control apparatus 20 in conjunction or use with the drying unit 10. The air flow control apparatus 20 is mounted below the drying unit 10. An area a, between the drying unit 10 and the frame member 25 is preferably in the range of four inches to six inches in order to provide enough space to allow a person to comfortably insert their hands (not shown) in the area a for drying purposes. As illustrated in FIG. 2B, the arrows represent the direction of the air flow. The downward arrows correspond to the air flow from the drying unit 10 which intersects with the frame member 24. Specifically, the air flow intersects with a first deflecting surface 24a of the frame member 24 causes the air flow to deflect towards the left side 22e of the bottom portion 22d of the housing 22 and substantially perpendicular to the floor surface s. Similarly, the air flow intersects with a second deflecting surface 24b of the frame member 24 causes the air flow to deflect towards the right side 22f of the bottom portion 22d of the housing 22 and substantially perpendicular to the floor surface s. This deflection of the air flow by the frame member 24 causes the air to move in a direction away from the floor surface s thus reducing or eliminating the particles p from traveling into the air proximate the floor surface s.

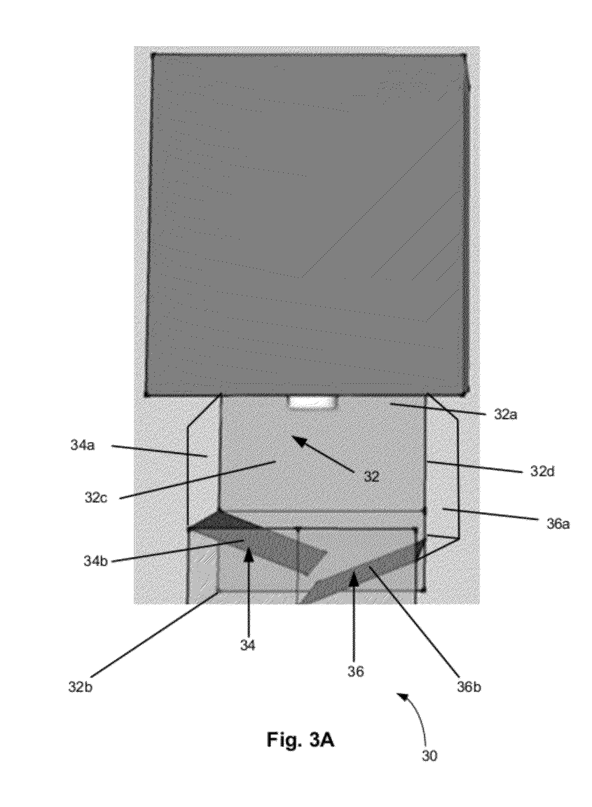

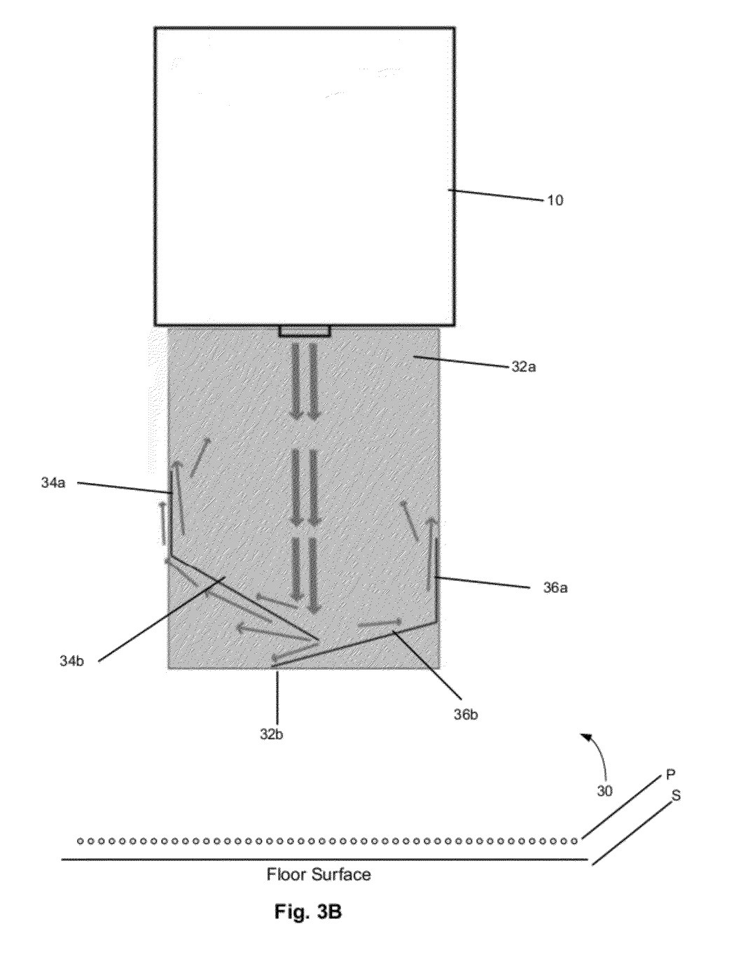

Referring to FIG. 3A there is shown a perspective view of an apparatus 30 to control the air flow in accordance with another embodiment of the present invention. The air controller apparatus 30 includes a housing 32 having an elongate, semi-enclosed substantially flat, planar member preferably to a wall (not shown). It is noted that the housing 32 is substantially rectangular in shape, however, the invention is not limited to a rectangular form and the housing may be another suitable shape such as for example, circular, triangular, square etc. The housing 32 is preferably made of any suitable, conventional sheet metal. However, one skilled in the art would appreciate that the housing may preferably be constructed of other materials such as plastic, wood, fiberglass etc. As shown in FIG. 3A, the housing 32 includes a top portion 32a, a bottom portion 32b, a front portion 32c and a rear portion 32d mounted to a wall (not shown). The apparatus 30 also includes a first frame member 34 having a substantially L-shape configuration securely connected to left side of the housing 32 and a second frame member 36 securely connected to right side of the housing. It is noted that the first and the second frame members 34 and 36 respectively are substantially of L-shape configuration, however, the invention is not limited to this shape and/or form and the frame members may be another suitable shapes and/or forms known to one skilled in the art. The first and the second frame members 34 and 36 respectively are preferably made of any suitable, conventional sheet metal. However, one skilled in the art would appreciate that the frame members may preferably be constructed of other materials such as plastic, wood, fiberglass etc. As illustrated in FIG. 3A, the first frame member 34 includes a first flat support surface 34a extending from the top portion 32a to the bottom portion 32b and a first deflecting surface 34b which preferably is an incline expanding from the flat support surface 34a towards center of the bottom portion 32b of the housing 32. As shown in FIG. 3A, the second frame member 36 includes a second flat support surface 36a extending from the top portion 32a to the bottom portion 32b and a second deflecting surface 36b which preferably is an incline expanding from the flat support surface 36a towards center of the bottom portion 32b of the housing 32. Even though the first and the second frame members 34 and 36 are shown as a one piece frame, alternatively, they may be two pieces of frames joined together with the similar configuration as appreciated by one skilled in the art. Both the first and the second frame members 34 and 36 respectively function as a baffle to direct air flow away from a floor surface (not shown) as will be described in greater detail with respect to FIG. 3B herein below.

Referring to FIG. 3B, there is shown a perspective view of the air flow control apparatus 30 in conjunction or use with the drying unit 10. The apparatus 30 is mounted below the drying unit 10. As illustrated in FIG. 3B, the arrows represent the direction of the air flow. The downward arrows correspond to the air flow from the drying unit 10 which intersects with the first and the second frame members 34 and 36 respectively. Specifically, the air flow intersects with the first deflecting surface 34b of the first frame member 34 which causes the air flow to deflect towards the first flat surface 34a of the first frame member 34 as show in FIG. 3B. Similarly, the air flow intersects with the second deflecting surface 36b of the first frame member 36 which causes the air flow to deflect towards the second flat surface 36a of the first frame member 36. Eventually, the air flows upwards and parallel to the first and the second flat surfaces 34a and 36a respectively, which is substantially perpendicular to the floor surface s. This deflection of the air flow by the first and the second frame members 34 and 36 drive the air flow in the direction away from the floor surface s thus reducing or even eliminating the particles p from traveling into the air proximate the floor surface s.

While the present invention has been described and illustrated in connection with the above embodiments, many variations and modifications, as will be evident in those skilled in the art, may be made without departing from the spirit and scope of the present invention. The embodiments of the present invention are thus not to be limited to the precise details of methodology or construction set forth above, as such variations and modifications are intended to be included within the scope of the present invention.

1. An apparatus for reducing the dissemination of particles located on a floor surface into the air proximate a forced air hand drying unit comprising:
a housing for mounting below the forced air hand drying unit; and
a frame member coupled to the housing, configured to intersect and deflect an air flow from the hand drying unit in a direction away from a floor surface.

2. The apparatus of claim 1 wherein the air flow intersected and deflected by the frame member flows in a direction substantially perpendicular to the floor surface.

3. The apparatus of claim 1 wherein the housing comprises flat planar member having a top portion and a bottom portion, wherein the bottom portion comprise a left side and a right side.

4. The apparatus of claim 1 wherein the frame member comprises a first deflecting surface having a first slope and a second deflecting surface having a second slope, the frame member coupled proximate to the bottom portion of the housing.

5. The apparatus of claim 4 wherein the first deflecting surface of the frame member is configured to intersect and deflect an air flow towards one of the left and the right side of the bottom portion of the housing to cause the air flow to move in a direction substantially perpendicular to a floor surface.

6. The apparatus of claim 5 wherein the second deflecting surface of the frame member is configured to intersect and deflect an air flow towards other of the left and the right side of the bottom portion of the housing to cause the air flow to move in a direction substantially perpendicular to the floor surface.

7. The apparatus of claim 1 wherein the housing comprises a flat planar member having a top portion and a bottom portion.

8. The apparatus of claim 7 wherein the frame member comprises a first frame and a second frame.

9. The apparatus of claim 8 wherein the first frame comprises a first flat surface extending from the top portion of the housing to the bottom portion of the housing and a first deflecting surface extending in an incline from the first flat surface.

10. The apparatus of claim 9 wherein the first deflecting surface of the first frame is configured to intersect and deflect the air towards the first flat surface such that the air flow moves in a direction substantially perpendicular to the floor surface.

11. The apparatus of claim 8 wherein the second frame comprises a second flat surface extending from the top portion of the housing to the bottom portion of the housing and a second deflecting surface extending in an incline from the second flat surface.

12. The apparatus of claim 11 wherein the second deflecting surface of the second frame is configured to intersect and deflect the air towards the second flat surface such that the air flow moves in a direction substantially perpendicular to the floor surface.

13. The apparatus of claim 1 wherein the housing is made of one of a metal, plastic, or fiberglass.

14. The apparatus of claim 1 wherein the frame member is made of one of a metal, plastic, or fiberglass.

15. A method for controlling air flow of a forced air hand drying unit, the method comprising:
mounting the apparatus of claim 1; and
operating the forced air hand drying unit.
